(19) United States
(12) Patent Application Publication
(10) Pub. No.: US 2007/0297873 A1
(43) Pub. Date: Dec. 27, 2007

(54) Thread-tapping screw

(76) Inventors: Juergen Wieser, Kaufering (DE); Johannes Dobler, Rankweil (AT)

Correspondence Address: ABELMAN, FRAYNE & SCHWAB, 666 THIRD AVENUE, 10TH FLOOR, NEW YORK, NY, 10017, US

(21) Appl. No.: 11/809,713

(22) Filed: Jun. 1, 2007

(30) Foreign Application Priority Data
Jun. 2, 2006 (DE) 10 2006 000 269.5

(51) Int. Cl. F16B 35/04

(52) U.S. Cl. 411/411

(57) ABSTRACT

A thread-tapping screw has a shaft (12) with first (13) and second (14) ends, a load application element (15) provided at one of the first and second ends (13, 14), a thread (16) extending at least regionwise along the shaft (12), and at least one wear indication element (21, 26, 31; 36, 41; 51, 56; 61, 66) provided on the thread (16).

### BACKGROUND OF THE INVENTION

1. Field of the Invention

The present invention relates to a thread-tapping screw including a shaft having first and second ends, load application means provided at one of the first and second ends, and a thread extending at least regionwise along the shaft.

2. Description of the Prior Art

Screws with a self-tapping thread for different constructional components are well known. Thus, German Publication DE 33 01 414 A1 discloses a thread-tapping screw for a mineral constructional component, e.g., such as concrete and including a shaft having first and second ends, load application means provided at one of the first and second ends, and a thread extending at least regionwise along the shaft.

The thread-tapping screw is screwed in a pre-drilled hole in a constructional component with an appropriate tool such as, e.g., a screw-driver, hammer drill, spanner and the like, with a front portion of the screw tapping a counter-thread corresponding to the screw thread. A following thread engages the counter-thread, whereby a load is transmitted to the constructional component. In a soft constructional component such as, e.g., foam mortar, or plaster board, the thread-tapping screws can be screwed in without preliminarily forming a hole.

An essential advantage of a thread-tapping screw is a possibility to screw the thread-tapping screw out of the constructional component, without a portion of the produce attachment remaining in the constructional component. In particular, thread-tapping concrete screws, which can be set in mineral constructional components, proved themselves in practice for temporary attachments, e.g., during formwork, scaffolding or for securing of drilling and cutting power tools in diamond drilling and cutting technology. The thread-tapping screws not only can be withdrawn but, in principle, can be used for a new application.

The drawback of a conventional thread-tapping screw, in particular of that which is set in a mineral component, consist in that the screw is subjected to wear as it is being screwed in. The degree of wear and, thus, wear of the thread flanks of the thread depends on local conditions in the constructional component, and the possibility of a multiple use of the thread-tapping screw cannot be predicted. Therefore, with a conventional thread-tapping screw, the load bearing characteristics can be guaranteed only at a first use. Therefore, even at temporary attachments, for each new setting process, a new thread-tapping screw needs to be used, and a possible advantage of reuse is not used.

Accordingly, an object of the present invention is to provide a self-tapping screw, in particular, a concrete screw that is capable of multiple use.

Another object of the present invention is to provide a self-tapping screw that permits to determine its load bearing behavior.

### SUMMARY OF THE INVENTION

These and other objects of the present invention, which will become apparent hereinafter, are achieved by providing at least one wear indication element on the thread.

The at least one wear indication element shows degree of wear of the thread and, thereby, permits to determine load-carrying characteristics of a dismounted thread-tapping screw. The user can clearly and simply recognize if a load-bearing capacity of a dismounted thread-tapping screw fell below a predetermined threshold and whether the dismounted screw can be used anew or not. A multiple use of a thread-tapping screw permits to reduce costs and resources, e.g., associated with storage and logistics, in particular at temporary attachments.

Advantageously, the at least one wear indication element is formed by a discontinuity region formed by at least one side of a thread flank of the thread being discontinued from a rim of the thread toward a thread root. The discontinuity region of the thread flank defines a shoulder. Alternatively, the discontinuity region can define and form a step the adjacent flank portions of which form an obtuse or super obtuse angle. Further, the discontinuity region can be formed by a depression extending substantially parallel to the free rim of the thread, e.g., in form of a groove. A shoulder, a step and/or groove can be provided on both sides of the thread flanks. Moreover, a side of the thread flank can have more than one shoulder, step, or groove.

Advantageously, the at least one wear indication element is formed by a recess which is provided on the thread and is clearly seen to the use. The recess is so dimensioned and positioned that at an abrasive wear of the thread when the recess cannot be recognized any more, a lower threshold of the load-bearing capacity of the thread-tapping screw has been reached.

Advantageously, the recess is formed on a side of a thread flank of the thread. Advantageously, the recess extends from a rim of the thread flanks by a predetermined amount toward the thread root and is defined by a minimal load-carrying capacity that still must be reached by the thread-tapping screw with a worn thread. According to a further embodiment, the recess is formed by a circumferentially closed depression formed at a predetermined distance form the outer rim of the thread flank.

Advantageously, another wear indication element is arranged in the recess that forms visual advance warning means. Advantageously, the another wear indication element is formed of a material that visually distinguishes from the material for producing the thread-tapping screw, e.g., a temporary free-flowing wear means can be cast into the recess.

Advantageously, the at least one wear indication element is formed by a marking provided on a thread flank, e.g., in form of a color layer or by region having a particular surface structure. The region with a particular surface structure, e.g., a particular profile that is formed on the thread, advantageously, during the production of the thread-tapping screw.

Advantageously, the at least one wear indication element is formed by a separate wear indication element. The separate wear indication element can be formed by pins, balls, cubes, cones or the like which are embedded into the thread, e.g., during manufacturing of the thread-tapping screw. When a predetermined degree of wear is reached the wearable body is freed. The visually warning wearable body communicates to the user that the load-bearing capacity of the thread-tapping screw fell below its lower threshold.

According to an alternative embodiment of the present invention, the separate wearable body is frictionally or form lockingly set in the recess, whereby upon a complete wear of the wearable body, a visual signal is communicated to the user that the load-bearing capacity of the thread-tapping screw fell below its lower threshold.

Advantageously, more than one wear indication elements are provided on a thread. The wear indication elements are located at different locations at a distance from each other so that more than one region of the thread can predict further use of the dismounted thread-tapping screw. Alternatively, several wear indication means are arranged at different distances from the rim of the thread flank, whereby not only the lower threshold of the load-bearing capacity of the thread-tapping screw but also an intermediate threshold are visually communicated to the user. Further, different kinds of wear indication elements can be provided on the thread of a thread-tapping screw, which insures a high reliability of prediction of remaining load-bearing capacity of the thread-tapping screw.

The novel features of the present invention, which are considered as characteristic for the invention, are set forth in the appended claims. The invention itself, however, both as to its construction and its mode of operation, together with additional advantages and objects thereof, will be best understood from the following detailed description of the preferred embodiments, when read with reference to the accompanying drawings.

### BRIEF DESCRIPTION OF THE DRAWINGS

In the Drawings:

FIG. 1 a side view of a first embodiment of a screw according to the present invention;

FIG. 2 a partial cross-sectional view along line II-II in FIG. 1;

FIG. 3 a partial cross-sectional view similar to that of FIG. 2 of a second embodiment of a screw according to the present invention;

FIG. 4 a schematic cross-sectional view through a thread flank of a third embodiment of a screw according to the present invention;

FIG. 5 a schematic cross-sectional view through a thread flank of a fourth embodiment of a screw according to the present invention; and

FIG. 6 a schematic cross-sectional view through a thread flank of a screw according to the present invention and showing two further embodiments of the inventive screw.

In the drawings, the same elements are shown with the same reference numerals.

### DETAILED DESCRIPTION OF THE PREFERRED EMBODIMENTS

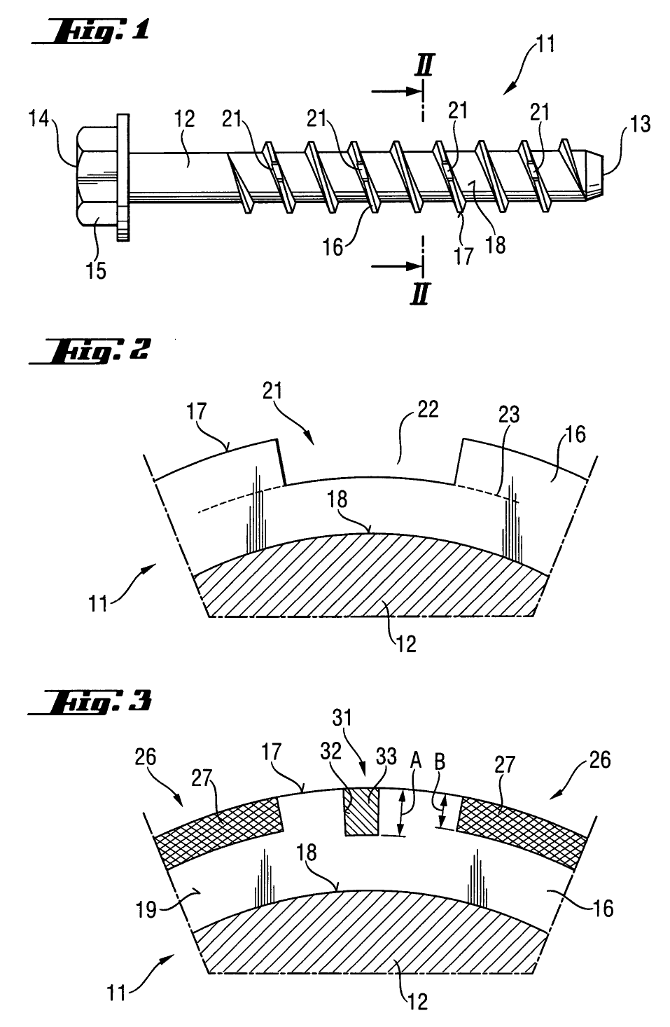

A thread-tapping screw 11 according to the present invention, which is shown in FIGS. 1-2, has a shaft 12 having opposite first 13 and second 14 ends. At the second end 14 of the shaft 12, there is provided load application means 15 in form of a hexagon head. The screw 11 further has a thread 16 extending regionwise over the length of the shaft 12. On the thread 16, there are provided several wear indication elements 21. The wear indication elements 21 are located in recesses 22 which extend from the rim 17 of the thread 16 to the thread root 18. When the regions of the thread 16 adjacent to the recess 22 wear off up to line 23 as a result of screwing of the thread tapping screw 11, e.g., in a mineral component, the recess 22 is not recognizable as such. Thereby, a visual signal is communicated to the user that the load bearing capacity of the thread tapping screw 11 fell below its lower threshold, and the screw should not be re-used any more for certain attachments.

FIG. 3 shows two different wear indication elements 26 and 31 provided on the thread 16. The wear indication element 31 is likewise formed as a recess 32 which is provided, however on a side 19 of flank of the thread 16. The recess 32 extends from the rim 17 of the thread 16 by an amount A in a direction of the thread root 18. The recess 32 is filled with wearable means 33 that, e.g., has another color than the material for manufacturing of the thread tapping screw 11. The wear indication element 26 is represented by marking 27 in form of a particular surface profile provided on the side 19 of the flank of the thread 16. The marking 27 extends from the rim 17 of the thread 16 by an amount B in the direction of the thread root 18. The extension amount B of the marking 17 is smaller than the extension amount A of the recess 32. When the markings 27 completely wear off as a result of screwing of the screw 11 in, a visual signal is communicated to the user that the load bearing capacity of the thread 16 became below the lower threshold. Thus, in this embodiment, the wear indication element 26 forms an advance warning system.

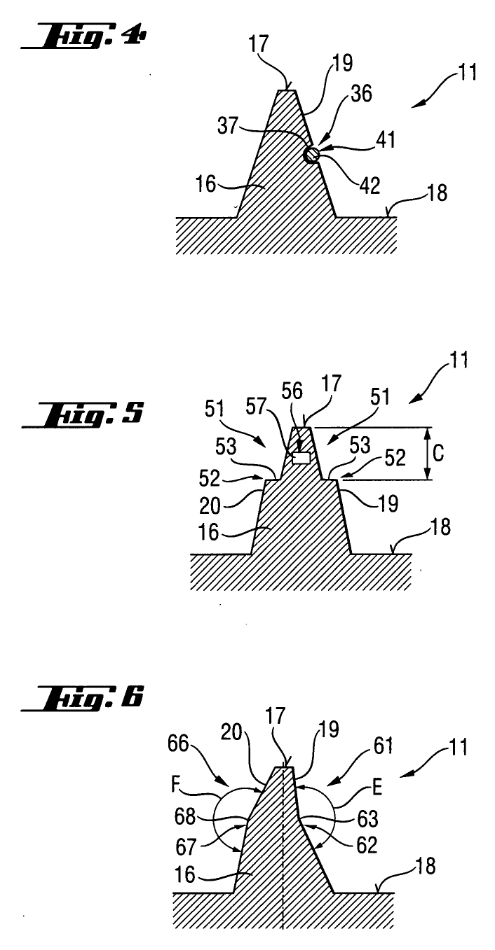

FIG. 4 shows a cross-sectional detail of a wear indication element 36 in form of a groove 37 extending parallel to the rim 17 of the thread 16 at a distance therefrom and formed in the side 19 of the flank of the thread 16. In the groove 37, there is arranged a further wear indication element 41 in form of a wearable body 42 formed as a ball which is fixedly secured in the groove 37.

FIG. 5 shows another cross-sectional detail of wear indication elements 51 formed by shoulders 53 of discontinuity regions 52 which are formed by two sides 19 and 20 of the thread flanks of the thread 16 being discontinued starting from the rim 17 of the thread flanks of the thread 16 in the direction of the thread 16 in the direction of the thread root 18. The shoulder 53 are spaced by the same distance C from the rim 17 of the thread 16.

A further wear indication element 56 is formed by a separate wearable body 57 embedded in a region between the shoulders 53 and the rim 17.

FIG. 6 shows a cross-sectional detail of yet another wear indication element 61 defined by an edge 63 of discontinuity region 62 formed on the side 19 of the thread flank of the thread 16 by the side 19 being discontinued from the rim 17 of the thread flank toward the thread root 18. The side sections of the side 19 adjacent to the edge 63 form an obtuse angle E. Another wear indication element 66 is formed by an edge 68 of discontinuity region 67 formed on the side 20 of the thread flank of the thread 16 by the side 20 being discontinued.

The side sections of the side 20 adjacent to the edge 68 form a super obtuse angle F. If upon dismounting of the thread-tapping screw 11, it is visualized that the flanks of the thread 16 wore off, as a result of the screw 11 being screwed in, up to the edges 63 and 68, the user recognizes that the load bearing capacity of the thread tapping screw 11 fell below its lower threshold, and the screw 11 cannot be used any more.

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A thread-tapping screw, comprising a shaft (12) having first (13) and second (14) ends; load application means (15) provided at one of the first and second ends (13, 14); a thread (16) extending at least regionwise along the shaft (12); and at least one wear indication element (21, 26, 31; 36, 41; 51, 56; 61, 66) provided on the thread (16).

2. A screw according to claim 1, wherein the at least one wear indication element (36; 51; 61, 66) is formed by a discontinuity region formed by at least one side (19, 20) of a thread flank of the thread (16) being discontinued from a rim (17) of the thread (16) toward a thread root (18).

3. A screw according to claim 1, wherein the at least one wear indication element (21, 31; 36) is formed by a recess (22, 32; 37) provided in the thread (16).

4. A screw according to claim 3, wherein the recess (22; 37) is formed on a side (19) of a thread flank of the thread (16).

5. A screw according to claim 3, wherein a further wear indication element (33) is arranged in the recess (32).

6. A screw according to claim 1, wherein the at least one wear indication element (26) is formed by a marking (27) provided on one of the thread flanks of the thread (16).

7. A screw according to claim 1, wherein the at least one wear indication element (41; 56) is formed by a separate wearable body (42; 57) provided on the thread (16).

8. A screw according to claim 1, wherein more than one wear indication elements are provided on the thread (16).
